(19) United States
(12) Patent Application Publication
(10) Pub. No.: US 2016/0007807 A1
(43) Pub. Date: Jan. 14, 2016

(54) CONTAINER

(71) Applicant: SEDA SUISSE A.G., Zug (CH)

(72) Inventor: Glanfranco D'Amato, Arzano (IT)

(21) Appl. No.: 14/766,892

(22) PCT Filed: Feb. 14, 2014
(86) PCT No.: PCT/IB2014/000157

§ 371 Date: Aug. 10, 2015

(30) Foreign Application Priority Data
Feb. 14, 2013 (IT) RM2013U000033

(51) Int. Cl. A47J 47/14; B65D 77/22; B65D 65/46

(52) U.S. Cl. CPC A47J 47/14; B65D 65/466; B65D 77/22

(57) ABSTRACT

There is provided a box-like container (1) for the storing and transporting of a food product, comprising a first half container (2) having a peripheral wall (20) with an edge region (21) and a bottom surface (22), and a second half container (3) having a peripheral wall (30) with an edge region (31) and a bottom surface (32), the container (1) is characterized in that said first and second half container (2,3) are mutually connectable via coupling of said first half (2) to said second half (3) at the edge regions (21,31) thereof, said edge regions (21,31) having a shape which it is complementary one to the other, and in that it comprises removable locking means (4) formed onto said edge regions (21,31).

The present invention relates to a box type container, and more specifically, to a box type container for the transporting and the subsequent consumption of a food product.

### STATE OF THE ART

Up to now, several kinds of box-type containers and which are suitable for the transporting of a food product therein contained from a selling point and the subsequent consumption are already known.

For example, in the large distribution of food to consumers such as the “fast foods” or the like, typically the food product is sold in biodegradable material box containers such as cardboard or the like, such types of containers being known with the name of “Clamshells”. This type of “clamshell” container must have certain features of stackability, resistance to temperature, resistance to food substances coming from the food product arranged inside thereof, etc.

Typically, a “clamshell” container must contain the food product in the shape of hot sandwich, must be rigid enough to be stacked with other similar types of box-like containers, and must have the possibility of being opened in two halves in order to have the food product consumed therein by way of tray or dish. Moreover, this type of container must be reclosable in case the user wants to preserve the remaining food product for its subsequent consumption.

Another feature which is required to such “clamshell” type containers for the selling of hot food products is to have a good thermal insulation, in such a way as to allow the food inside thereof to remain hot as long as possible, to the advantage of the user.

Up to now, all types of known “clamshell” containers on the market try to satisfy these requirements in a more or less satisfactory manner.

The present invention aims to provide a “clamshell” container which has improved features of thermal insulation, rigidity, and functionality compared to this type of containers of the state of the art.

### BRIEF DESCRIPTION OF THE INVENTION

Therefore, the present invention provides an improved “clamshell” type container for a food product, which has a structure with improved rigidity.

In another aspect of the present invention, there is provided an improved “clamshell” container for a food product of which has a better insulation.

According to a further aspect of the present invention, there is provided an improved “clamshell” type container for a food product and which has a high versatility.

Thus, the present invention provides an improved “clamshell” container for a food product substantially according to the appended claims.

### DESCRIPTION OF THE INVENTION

A detailed description of two preferred embodiments of the container of the present invention will now be given, given by way of a non-limiting example, with reference to the accompanying figures, wherein:

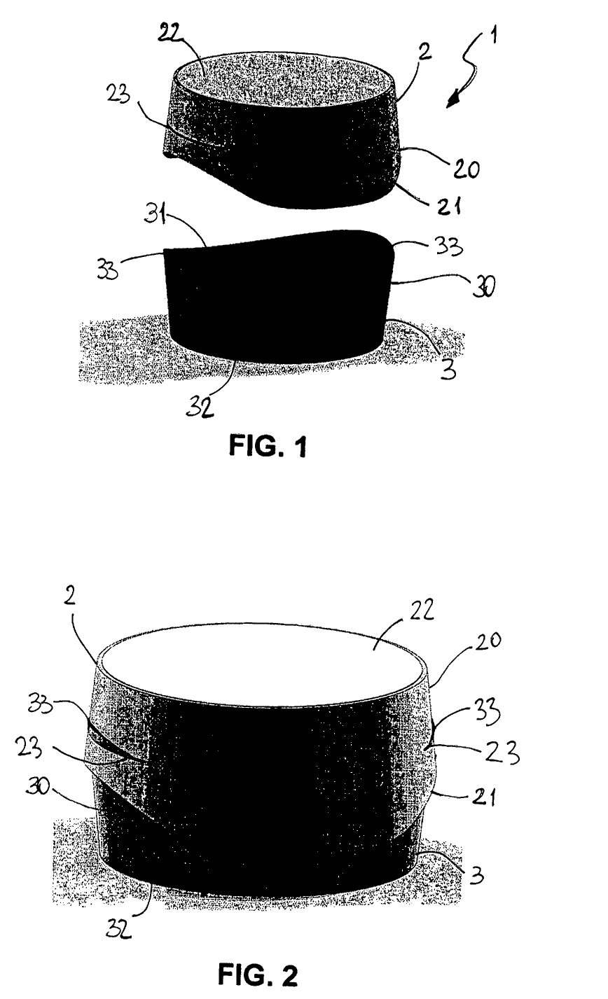

FIG. 1 is a perspective exploded view of the container of the present invention;

FIG. 2 is a front perspective view of the container of the present invention in the closed condition;

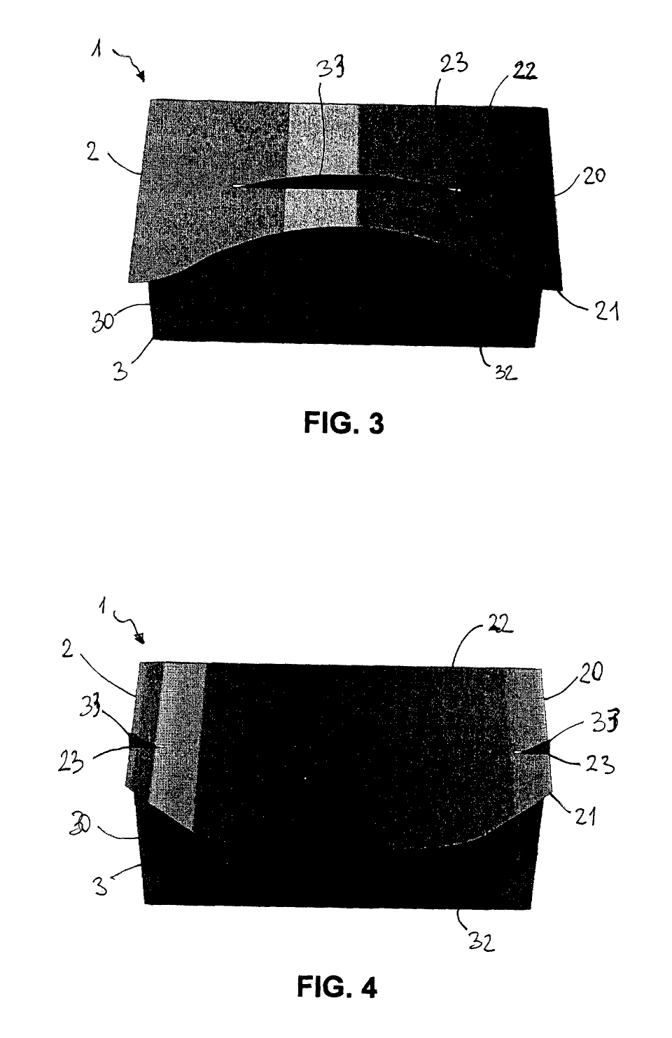

FIG. 3 is an elevational view from one side of the container of the present invention in the closed condition;

FIG. 4 is a front elevational view of the container of the present invention in the closed condition;

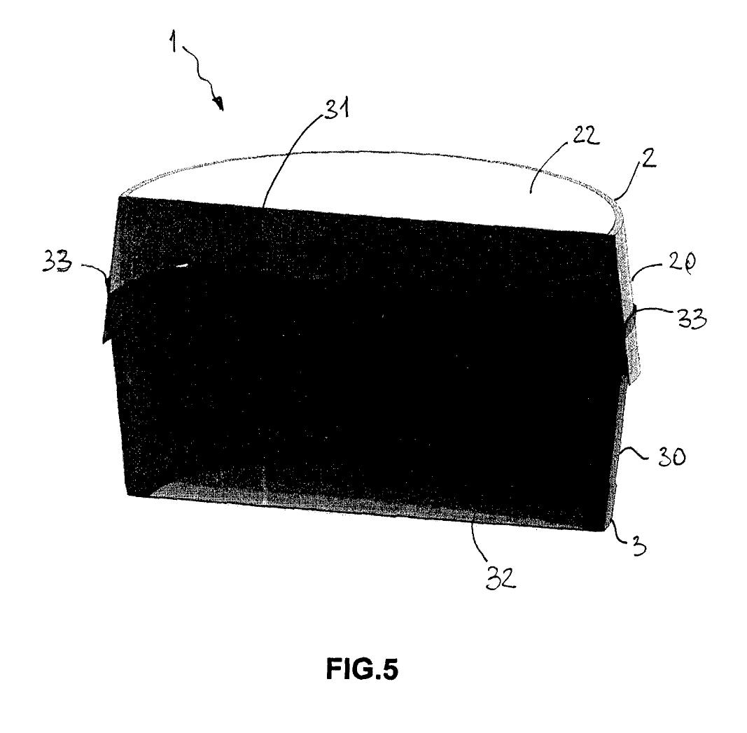

FIG. 5 is a cross sectional view of the container of the present invention in the closed condition;

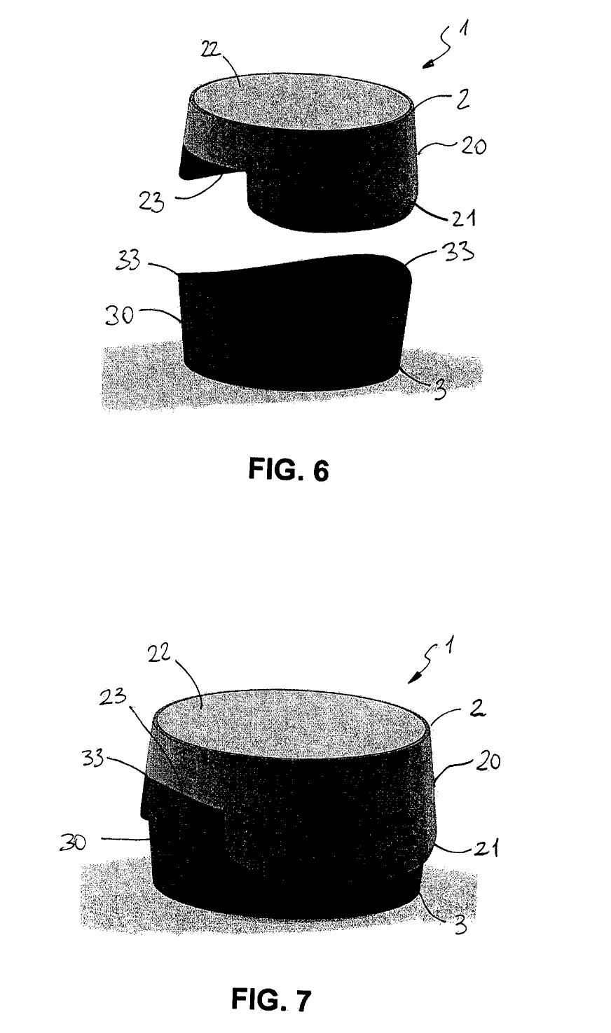

FIG. 6 is an exploded view of a second embodiment of the container of the present invention; and

FIG. 7 is a perspective view from above and from one side of the container of FIG. 6 in the closed condition.

With reference now to FIGS. 1 and 2, there is illustrated the container for the storing and transporting of a food product of the present invention.

According to the present invention and with particular reference to FIG. 1, there is provided a box-like container 1 which is constituted by a first half container 2 having a peripheral wall 20 with an edge region 21 and a bottom surface 22, and a second half container 3 having a peripheral wall 30 with an edge region 31 and a bottom surface 32.

With particular reference to FIG. 2, there is shown the container 1 in the closed condition. As can be seen in the figure, the first half container 2 and the second half container 3 are mutually connected by means of the coupling of said first half 2 with said second half 3 onto their edge regions 21 and 31, respectively. It should be noted here that said edge regions 21 and 31 have a complementary shape one to another.

Moreover, removable locking means for said two respective halves 2 and 3 are formed at the edge region 21, said locking means being constituted by a pair of slots 23 for receiving the respective regions 33 of the projecting edge regions 31 of said second half 3.

With reference now to FIGS. 3 and 4, it can be noted in them the particular arrangement of the box-like container 1 in the closed condition. As evident in the figures, the edge regions 21 and 31 of said first and second half 2 and 3 are respectively “wave” shaped and are complementary one to the other. Furthermore, as is evident in the figures when the container 1 is in the closed condition, the bottom 23 and 33 parts have an horizontal arrangement, and are parallel to the surface where the container 1 rests.

With particular reference now to FIG. 5, it can be noted how when the box-like container 1 it is in the closed condition, the shape of the edge regions 21 and 31 is such that one rests onto the other in a perfectly contacting way, thereby creating a closure of the container 1 without discontinuity.

Furthermore, and with reference to the preceding figures, according to the present invention it is evident that the first half 2 and second half 3 have a substantially cylindrical shape with a circular base in such a way that when the container 1 it is closed it shows a substantially cylindrical shape. Additionally, as it appears form the figures according to the present invention the perimeter walls 20 and 30 of the respective first and second half 2 and 3 show a substantially frustoconical shape having a circular base.

With reference now to FIGS. 6 and 7, it is illustrated therein an alternative embodiment of the box-like container 1 of the present invention. For the sake of clarity, same parts have same numerals, and the detailed description thereof will be hereafter omitted since it has already been given.

As can be understood from the figures, according to this second embodiment, the locking means 4 are constituted by a region 23 which has a “U” shape, and it is formed at the edge portion 21 of the wall 20 of the first half of the container 2. The region 23 is adapted to accommodate completely the protruding part 33 of the second half of the container 3, thus realizing the mutual locking of the two parts 2 and 3, respectively.

The container 1 of the present invention has a number of advantages. According to a first advantageous aspect of the present invention, the container 1 has a structure with improved rigidity compared to the state of the art containers of this type (clamshells). In fact, the shaping of the walls 20 and 30 allows to provide a container 1 which, when it is in the closed condition, its walls result in a substantially vertical arrangement, thus greatly improving the structural strength of the container 1.

According to a second advantageous aspect of the present invention, the container 1 when it is in the closed condition has a high insulation. This thanks to the shape and arrangement of the walls 20 and 30, and the shape of the container 1 itself.

According to a third advantageous aspect of the present invention, the container 1 has a high versatility. Indeed, the fact of presenting two halves 2 and 3 which are separable one from the other, allows a more versatile distribution of its contents (food) and a greater easy of use for the user when compared with the state of the art containers of this type (clamshell).

1. A box-like container (1) for the storing and transporting of a food product, comprising a first half container (2) having a peripheral wall (20) with an edge region (21) and a bottom surface (22), and a second half container (3) having a peripheral wall (30) with an edge region (31) and a bottom surface (32),
characterized in that said first and second half container (2,3) are mutually connectable via coupling of said first half (2) to said second half (3) at the edge regions (21,31) thereof, said edge regions (21,31) having a shape which it is complementary one to the other, and in that it comprises removable locking means (4) formed onto said edge regions (21,31).

2. A box-like container (1) for the storing and transporting of a food product according to the preceding claim, wherein said locking means (4) comprises at least one protruding region (33) formed on said edge region (31) of said second half (3), and an insertion region (23) which is complementary to said protruding region (33), said insertion region (23) being formed on said edge region (21) of said first half (3).

3. A box-like container (1) for the storing and transporting of a food product according to the preceding claim, wherein said insertion region comprises a slot (23).

4. A box-like container (1) for the storing and transporting of a food product according to claim 2, wherein said insertion region comprises a “U” shaped region (23).

5. A box-like container (1) for the storing and transporting of a food product according to any of the preceding claims, wherein said edge regions (21,31) of said first and second half (2,3) of the container have each a wavy shape and which is complementary one to the other.

6. A box-like container (1) for the storing and transporting of a food product according to any of the preceding claims, wherein when the container (1) is in the closed condition, said bottom parts (22,32) are arranged horizontal and parallel with respect to the surface where the container (1) rests.

7. A box-like container (1) for the storing and transporting of a food product according to any of the preceding claims, wherein when the container (1) is in the closed condition, said edge regions (21,31) rest one onto the other in a perfectly adhering manner and creating a closing of the container (1) without discontinuity.

8. A box-like container (1) for the storing and transporting of a food product according to any of the preceding claims, wherein said first and second half container (2,3) have a substantially cylindrical shape with a circular base.

9. A box-like container (1) for the storing and transporting of a food product according to the preceding claim, wherein said outer walls (20,30) of said first and second half container (2,3) have a substantially frustoconical shape with circular base.
